(19) United States
(12) Patent Application Publication
(10) Pub. No.: US 2008/0198030 A1
(43) Pub. Date: Aug. 21, 2008

(54) Gravestones or Memorials

(76) Inventor: Mark John Pringle, Weltevreden Park (ZA)

Correspondence Address: THE H.T. THAN LAW GROUP, WATERFRONT CENTER SUITE 560, 1010 WISCONSIN AVENUE NW, WASHINGTON, DC, 20007, US

(21) Appl. No.: 11/915,197

(22) PCT Filed: May 26, 2006
(86) PCT No.: PCT/IB06/51681

§ 371 Date: Nov. 21, 2007

(30) Foreign Application Priority Data
May 26, 2005 (ZA) 2005/04307

(51) Int. Cl. G08B 21/18; E04H 13/00; G08B 1/08

(52) U.S. Cl. 340/687; 52/103; 340/539.16

(57) ABSTRACT

The invention provides a memorial assembly (10) including a memorial structure (11) and a security device (16) secured to the memorial structure (11). The security device (16) includes a sensing device for sensing disturbance of the memorial structure (11). The security device (16) also includes a transmitter operatively connected to the sensing device, to generate a wireless alarm signal in response to sensing of disturbance of the memorial structure (11) by the sensing device. The invention also provides a memorial security system which includes the memorial assembly (10) and also a transceiver module which receives the wireless alarm signal and which produces at least one notification message, such as a telephonic text message to prespecified notification address.

THIS INVENTION relates to the securing of gravestones or memorials for burial sites. It particularly relates to a gravestone or memorial assembly, and to a memorial security system. The invention extends to a memorial security device, and to a method of securing a memorial structure.

The invention provides a memorial assembly which includes:

a memorial burial structure, such as a gravestone;

a security device secured to the memorial structure, the security device including a sensing device for sensing disturbance of the memorial structure, and a transmitter operatively connected to the sensing device to generate a wireless alarm signal in response to sensing of disturbance of the memorial structure by the sensing device.

The assembly typically includes an electronic processor connected to the sensing device and to the transmitter, to process electronic signals received from the sensing device, and to cause the transmitter to transmit an alarm signal in response to sensing of disturbance of the memorial structure. The processor may be configured to generate unique identification information for inclusion in the alarm signal, to enable identification of the particular security device from which an alarm signal originates. It will be appreciated that the security device may form one of a plurality of security devices which send alarm messages to a common destination, so that discrimination of alarm messages originating from different security devices is possible because of the identification information.

Further, the security device may be provided with a memory means for storing details of specified addresses to which notification messages are to be sent.

The sensing device may include an orientation sensor which is configured to sense the orientation of at least part of the memorial structure, and to cause generation of the alarm signal when the measured orientation of at least part of the memorial structure falls outside of prespecified orientation parameters. In one embodiment of the invention, the orientation sensor is a tilt sensor for sensing when a part of the memorial structure on which the tilt sensor is mounted is tilted by more than a prespecified angle from an operative position. With operative position is meant the position in which the particular part of the memorial structure is placed during the erection or installation. The prespecified angle beyond which an alarm signal is triggered may be 30°-60°, preferably being about 45°.

The memorial structure may comprise a headstone portion which is supported on and secured to a base portion, the tilt sensor being mounted on the headstone portion to sense tilting of the headstone portion.

It is to be appreciated that the sensing device for sensing disturbance of the memorial structure need not be a tilt sensor, but can be any sensor for identifying disturbance of the structure, for instance being a movement sensor, a location tracking system, or the like.

The memorial structure may thus be of composite construction, the sensing device being configured to trigger generation of the alarm signal in response to separation of two parts of the memorial structure. Again, the memorial structure may include a headstone portion and a base portion on which the headstone portion is supported, the sensing device being fixedly secured to the memorial structure such that it senses relative displacement or removal of the headstone portion relative to the base portion. In such case, the headstone portion may be secured to the base portion by at least one securing rod, each rod being received in a pair of complementary aligned passages provided in the base portion and the headstone portion respectively, each passage in the base portion intruding from an operatively upper face of the base portion, and each passage in the headstone portion intruding from an operatively lower face of the headstone portion, the upper and lower faces of the base portion and the headstone portion abutting, when the memorial structure is in its operative condition.

The sensing device may include a separation sensor having an elongated casing in which is fixedly secured in complementary aligned passages in the headstone portion and the base portion, the casing having a zone of weakness more or less aligned with the abutment between the base portion and the headstone portion, the separation sensor being configured to sense damage, such as breakage, of the casing in the zone of weakness and, in response thereto, to trigger generation of the alarm signal.

Advantageously, the security device may include a tracking device which is located in the headstone portion, so that it moves with the headstone portion if the headstone portion is removed, the tracking device producing a tracking signal for facilitating location of the headstone portion. The tracking device will preferably be fixedly secured to the headstone portion, to inhibit unauthorised removal of the tracking device. Advantageously, the tracking device may also be operatively connected to the sensing device, being configured only to commence transmitting the tracking signal upon sensing by the sensing device of excessive movement of or disturbance of the position of the gravestone or memorial. Conveniently, the tracking device may be in the form of, or may be similar to, a tracking device conventionally used in the context of motor vehicles.

The power supply or battery, the transmitter and the tracking device of the security device may be secured to that part of the device which is located in the passage provided in the headstone portion, to permit said tracking of the headstone portion when it is stolen. Advantageously, the device will be fixedly secured to the headstone portion, to resist removal thereof from the headstone portion once the headstone portion has been separated from the base portion.

The transmitter may include a radio frequency antenna, thus being configured for transmitting a radio frequency alarm signal to a remote station. In a particular embodiment of the invention, the transmitter may be configured to transmit the alarm signal to at least one mobile telephone device. To this end, the transmitter may include a mobile telephone network communication device, such as a GSM module or modem.

The device may be configured to transmit a notification message in the form of an electronic text message to at least one specified address. The electronic text messages may be in the form of SMS or similar telephonic messages, e-mail messages, or the like.

Excessive movement of the gravestone or memorial or disturbance of the position of the gravestone or memorial will typically be the result of a natural occurrence such as, for example, movement of the ground in close proximity of the gravestone or memorial, or it will be the result of vandalism, such as when the gravestone or memorial, or part thereof, is forcefully knocked over. Naturally, removal of the gravestone or memorial from the gravesite, for example, during theft of the gravestone or memorial, will also result in excessive movement of the gravestone or memorial and disturbance of the position of the gravestone or memorial. Thus, when the operative position of the gravestone or memorial has, for whatever reason, been disturbed, the device will automatically transmit a said alarm signal to each specified address, thereby notifying a party associated with each specified address of such excessive movement or disturbance, so that said associated party or parties can investigate the status of the gravestone or memorial.

The device preferably includes a mobile power source, such as a battery, connected to both the sensing device and the transmitter. The battery may have a lifetime of at least three years and may optionally be mounted on the memorial structure so as to facilitate replacement thereof.

In a preferred embodiment, the transmitter may be configured for producing a radio frequency alarm signal with a localised range, to transmit the alarm signal to a transceiver module located in relative proximity to the memorial assembly. With “localised range” is meant that the range of the transmitter is sufficient to produce a signal which is receivable by a transceiver module located at a cemetery where the memorial assembly is located, such that the transceiver module is in the range of any memorial assembly in the cemetery. Typically, the range of the transmitter may be 50-200 m, preferably being about 100 m. The term “relative proximity” is to be understood in the same context as “localised range”.

The invention extends to a memorial security system which includes:

a memorial assembly as defined above;

a transceiver module located within range of the transmitter of the memorial assembly, to receive the alarm signal and to produce at least one notification message to prespecified notification address.

The transceiver module may include a mobile telephone communication module, such as a GSM module, for communicating the notification signal to each prespecified notification address via a cellular telephone network.

The system may include an information database having stored thereon an identification information of each of a plurality of security devices, as well as at least one notification address associated with each security device, the system being operable to identify unique identification information in any alarm signal generated by a security device, and to interrogate the database to establish each associated notification address.

The transceiver module may be installed at a memorial site, typically a cemetery or graveyard, so that it is within range of at least one security device mounted on a memorial structure at that memorial site, the transceiver module having a communication means for communicating the notification signal or the alarm signal to a remote control station. In one embodiment of the invention, the transceiver module includes a communication arrangement comprising the GSM module, to communicate with the remote control station via a mobile telephone network. In such case, the database may be located at the remote control station, in communication with a server computer at the control station.

Typically, the system may include a plurality of transceiver modules installed at respective memorial sites, each transceiver module being operable to transmit notification signals or alarm signals to the control station.

The system preferably includes a notification messaging arrangement for sending a text notification message to each prespecified notification address, the notification messaging arrangement preferably being configured for generating telephonic text messages, such as SMS messages. Instead, or in addition, the notification messaging arrangement may be connected to a public computer network, such as the Internet, to send text notification messages in the form of e-mails or the like to e-mail addresses associated in the database with respective security devices. .

The invention also provides a memorial security device for attachment to a memorial structure, which the security device includes:

a sensing device for sensing disturbance of a memorial structure to which the security device is, in use, attached; and

a transmitter operatively connected to the sensing device to generate a wireless alarm signal in response to sensing of disturbance of the memorial structure by the sensing device.

The memorial security device is preferably a security device as defined above with reference to a memorial assembly. The device may thus include an electronic processor connected to the sensing device and to the transmitter, to process electronic signals received from the sensing device, and to cause the transmitter to transmit an alarm signal in response to sensing of disturbance of the memorial structure. The security device is preferably configured to include unique identification information in the alarm signal.

The sensing device may include an orientation sensor which is configured to sense the orientation of at least part of the memorial structure on which the device is, in use, mounted and to trigger generation of the alarm signal when the measured orientation exceeds prespecified orientation parameters, the orientation sensor optionally being a tilt sensor.

The security device may be configured for mounting on a memorial structure of composite construction, the sensing device being arranged to trigger generation of an alarm signal in response to separation of two parts of the memorial structure.

The invention also extends to a method of securing a memorial structure, which method includes:

attaching a security device to the memorial structure;

monitoring the memorial structure by the security device, to sense disturbance of the memorial structure; and

automatically generating an alarm signal in response to measurement of disturbance of the memorial structure by the security device.

The method may comprise generating the alarm signal in response to sensing that a part of the memorial structure on which the security device is mounted has been tilted beyond prespecified parameters.

The method may include sending an electronic text message to at least one prespecified notification address in response to generation of the alarm signal.

The invention is now described, by way of example, with reference to the accompanying diagrammatic drawings.

In the drawings:

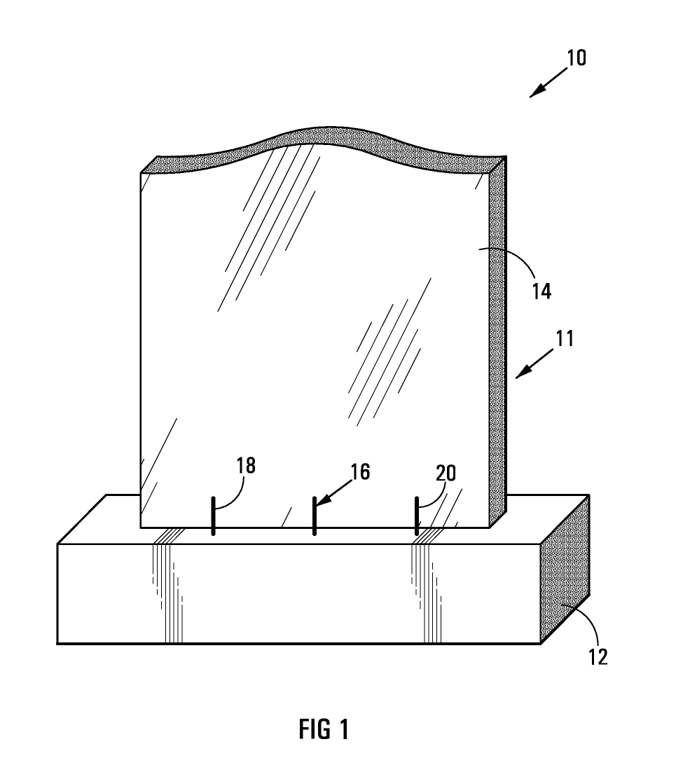

FIG. 1 shows, schematically, a three-dimensional view of one embodiment of a gravestone or memorial assembly in accordance with the invention;

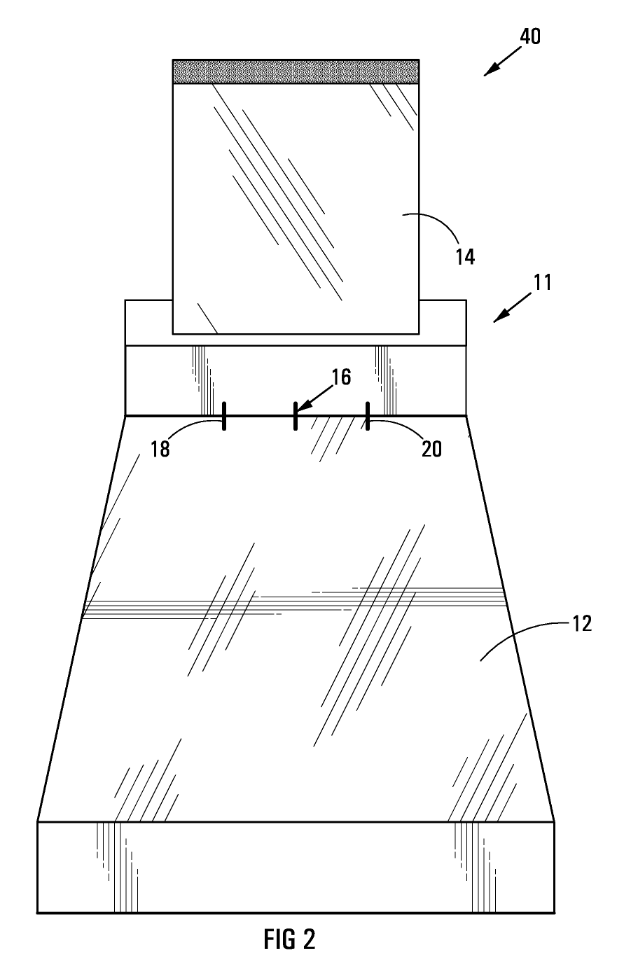

FIG. 2 shows, schematically, a three-dimensional view of another embodiment of a gravestone or memorial assembly in accordance with the invention;

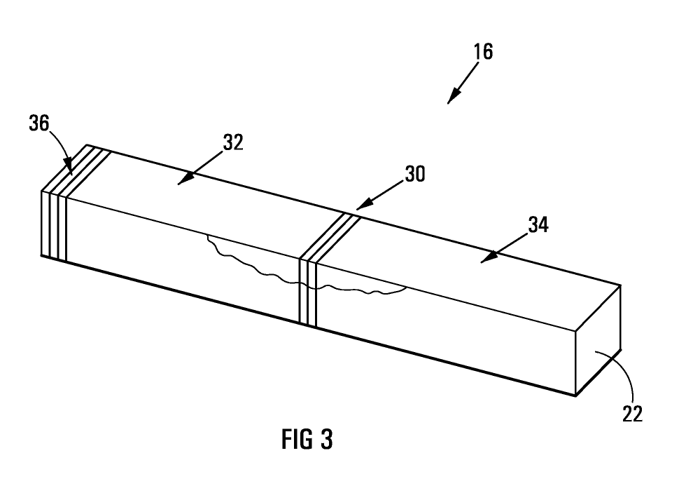

FIG. 3 shows, schematically, a three-dimensional view of a security device in accordance with the invention, the device forming part of the assemblies shown in FIGS. 1 and 2;

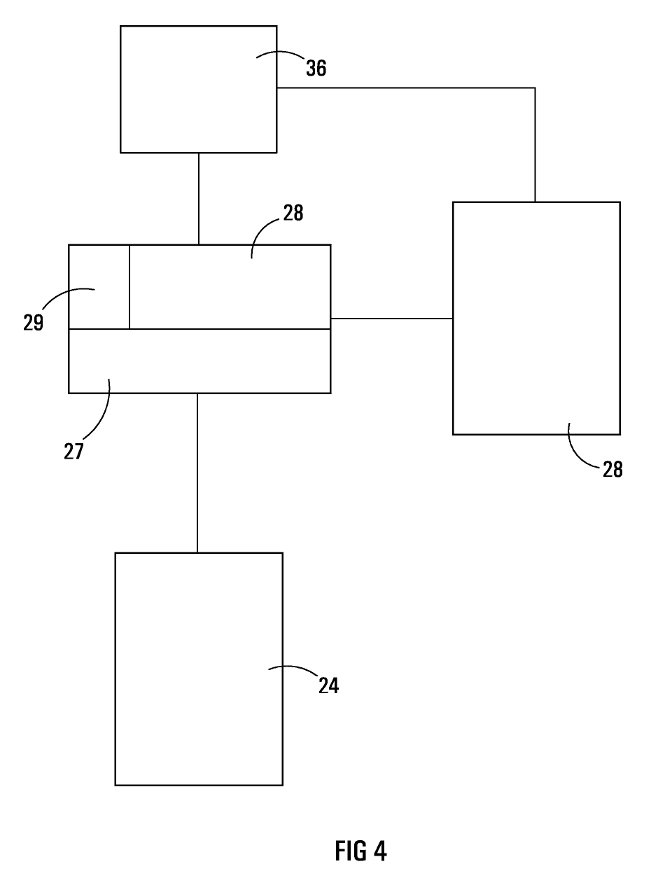

FIG. 4 shows, schematically, a component diagram of the device shown in FIG. 3; and

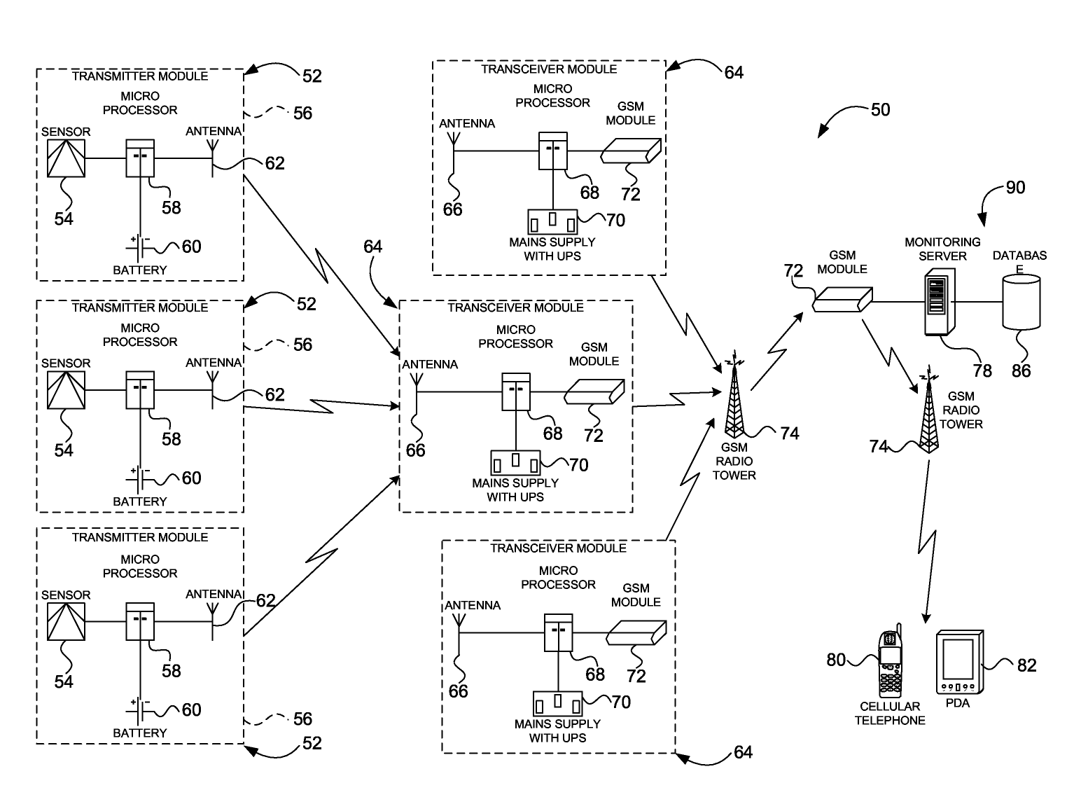

FIG. 5 shows a schematic component diagram of a memorial security system in accordance with the invention.

With reference to FIG. 1 of the drawings, one embodiment of a gravestone or memorial assembly in accordance with the invention is generally designated by reference numeral 10. The gravestone or memorial assembly 10 includes a composite gravestone or memorial 11 operatively located or positioned at a gravesite, the gravestone or memorial 11 comprising an elongated box-shaped base- or pedestal portion 12 which is located in the ground (not shown), and an operatively upright headstone portion 14 supported on and secured to the base portion 12.

The gravestone or memorial assembly 10 further includes a device 16 (see in particular FIGS. 3 and 4) in accordance with the invention secured to the gravestone or memorial 11, as hereunder described. The device 16 is configured for notifying a designated party in case of excessive movement of the gravestone or memorial 11 or in case of disturbance of the position of the gravestone or memorial 11.

The headstone portion 14 is secured to the base portion by means of two steel rods or dowels 18, 20. In particular, although not visible in FIG. 1, an operatively upper face of the base portion 12 is provided with two passages longitudinally spaced along the length of the base portion 12, and an operatively lower face of the headstone portion 14 is provided with two complementary passages aligned with said passages provided in the headstone portion 12. An operatively lower part of each rod or dowel 18, 20 is thus received in one of the passages in the base portion 12, and an operatively upper part of each rod or dowel 18, 20 is received in one of the passages provided in the headstone portion 14. In particular, the rods or dowels 18, 20 are secured in their respective passages by means of settable cementitious material.

Referring in particular to FIGS. 3 and 4, the device 16 includes an elongated box-shaped casing or housing 22 within which is housed a sensing device 24 (shown in concept only), a transmitter 26 (shown in concept only), a processor 27, a memory means 29, and a power supply in the form of a battery 28 (also shown in concept only). The casing or housing 22 has more or less the same shape and size as the rods or dowels 18, 20 and is also received in a pair of complementary passages, said pair of complementary passages being provided between the passages in which the rods or dowels 18, 20 are received. Like the rods or dowels 18, 20, the device 16 is also secured in its passages by means of a settable cementitious material, thereby resisting removal of the device 16 from the gravestone or memorial 11.

In particular, as can be seen in FIG. 3, the casing or housing 22 is provided with a zone of weakness 30, which zone of weakness 30 is located more or less midway between ends of the casing or housing 22. In use, the zone of weakness 30 is more or less aligned with the abutment provided between the lower face of the headstone portion 14 and the upper face of the base portion 12. In particular, the zone of weakness 30 divides the device 16 into a headstone part 32 which is secured to the headstone portion 14, and a base part 34 which is secured to the base portion 12. The headstone part 32 of the device 16 thus defines the aforementioned upper part of the device 16, and the base part 34 defines the aforementioned lower part of the device 16.

A tracking device 36 (shown in concept only), which also forms part of the device 16, is mounted on the casing or housing 22. The tracking device 36 is housed in the casing or housing 22 in the headstone part 32 thereof.

The sensing device 24 is arranged such that it senses damage of the device 16 along the zone of weakness 30. Thus, when the gravestone or memorial assembly 10 is subjected to excessive movement or its operative positioning is disturbed, which could be the result of a natural occurrence or could be the result of vandalism, relative movement between the headstone portion 14 and the base portion 12 will cause the casing or housing 22 to be damaged along the zone of weakness 30. Said damage will result in sensing of said excessive movement or disturbance by the sensing device 24. Naturally, when the headstone portion 14 is separated from the base portion 12, the device 16 will break along the zone of weakness 30, thus also resulting in sensing of said disturbance of the position of the headstone portion 14 relative to the base portion 12 by the sensing device 24.

The sensing device 24 is operatively connected, via the processor 27, to the transmitter 26, which is configured, in response to sensing of excessive movement of or disturbance of the position of the headstone portion 14 to the base portion 12, to transmit a radio frequency (RF) alarm signal to a predetermined destination that said disturbance or excessive movement has been sensed. Naturally, the sensor 24, the processor 27, and the transmitter 26 are operatively connected to and powered by the battery 28. Further, the memory means 29, which is operatively connected to the processor 27, is pre-programmed with the predetermined destination. In this example, the processor 27 is configured, upon sensing of such disturbance or excessive movement by the sensor 24, to effect transmission, via the transmitter 26, of a alarm signal to a cellular- or mobile telephone of a party associated with the cellular or mobile telephone. The alarm signal is transmitted via short message service (SMS).

Thus, when the gravestone or memorial 11 is subjected to excessive movement, which may occur on account of soil movement in the vicinity of the assembly 10, or which may occur as a result of the headstone portion 14 being knocked over by vandals or the like, the associated party, typically the next of kin of a buried person associated with the gravestone or memorial 11, said associated party will be notified that a disturbance has occurred and can then investigate the matter further and repair the gravestone or memorial 11 if necessary. Thus, the device 16 notifies said associated party when maintenance or repair of the gravestone or memorial 11 may be required.

The tracking device 36 is also powered by the battery 28 and, in case of theft of the headstone portion 14, will transmit a tracking signal which will permit tracking of the headstone portion 14. Typically, the device 16 is configured such that the tracking device 36 will only commence transmitting a tracking signal once the device 16 has been broken along the zone of weakness 30. The tracking device 36 is in the form of a tracking device conventionally used for motor vehicles and, accordingly, is not described in any further detail.

Referring now in particular to FIG. 2 of the drawings, another embodiment of a gravestone or memorial assembly in accordance with the invention is generally designated by reference numeral 40. The gravestone or memorial assembly 40, in most respects, resembles the gravestone or memorial assembly 10 and, accordingly unless otherwise indicated, reference numerals used to indicate parts or features of the gravestone or memorial assembly 10 are also used to indicate like parts or features of the gravestone or memorial assembly 40.

In this embodiment, the gravestone or memorial is also of composite construction, including a vertically flattened base portion 12 which is laid flat on the ground, and a headstone portion 14 secured to the base portion 12 in a similar fashion as that hereinbefore described with reference to the gravestone or memorial assembly 10. Further, the device 16 forming part of the gravestone or memorial assembly 40 operates in exactly the same fashion as the device 16 of the gravestone or memorial assembly 10 and, accordingly, the gravestone or memorial assembly 40 is not described in any further detail.

In FIG. 5 of the drawings, reference numeral 50 indicates a cemetery security system in accordance with the invention, the system 50 including a plurality of security devices 52 similar to the security device 16 described with reference to FIGS. 1-3. Like reference numerals indicate like parts in FIGS. 1-3 and in FIG. 4, unless otherwise indicated.

In the system 50 of FIG. 5, the sensing device for sensing disturbance of a gravestone (not shown in FIG. 4) is in the form of a tilt sensor 54 for sensing when the headstone of a gravestone on which it is mounted tilts by more than 45° from its original, operative position. The security device 52 has a hollow casing 56 (indicated in dotted lines in FIG. 4) in which electronic components are housed, the casing 56 being secured to the gravestone's headstone. It is also possible to mount more than one security device 52 on a single memorial structure or gravestone, for example where not only the headstone, but also an associated statue or ornament is to be protected.

The device 52 is thus essentially a transmitter module which includes a tilt sensor 54, as described above, an electronic processor 58 connected to the tilt sensor 54, and a transmitter in the form of an antenna 62. In contrast to the security device 16 described with reference to FIGS. 1 to 3, the device 52 does not include a GSM module for communicating with mobile telephones via a GSM network. Instead, the system 50 includes a localised transceiver station or module 64 which is situated on a gravesite or cemetery where the memorial structure in question is located, the transceiver module 64 being within range of the security device's antenna 62. In this example, the antenna 62 of each security device 52 has a range of about 100 m.

It will be appreciated that the antenna 66 of the security device 52 has substantially reduced cost and power requirements, when compared to the transmitter 26 of the device 16 of FIG. 3, as the signal which it produces need only be received by the localised transceiver module 64, instead of communicating with a remote radio frequency receiver or a cellular telephone tower. In other embodiments of the invention however, the transmitter of the security device 52 can be configured to communicate directly with a mobile telephone network.

The electronic processor 58 of the security device 52 is configured to process signals received from the tilt sensor 54, and to trigger the sending of an alarm signal by the antenna 62 to the transceiver module 64 in response to measurement by the tilt sensor 54 of excessive tilting of the headstone. In addition, the electronic processor 58 serves to include a unique identification code or signal in the alarm signal, so that the particular security device 52 from which an alarm signal originates can be identified.

The battery 60 of the security device 52 is an off-the-shelf unit which has a life of at least three years.

As mentioned above, the transceiver module 64 is located at a cemetery, and is operable to receive alarm signals from a plurality of security devices 52 mounted on respective gravestones in that cemetery. The transceiver station or module 64 includes a receiving antenna 66 for receiving the radio frequency alarm signal from any one of the security devices 52, and a processor 68 connected to the antenna 66. The transceiver module 64 further includes a mobile telephone communication device in the form of a GSM module 72 for communicating the alarm signal or a processed notification message or signal to a remote control station 90 via a GSM network 74. The transceiver module is powered by a mains supply with a backup battery or uninterruptible power supply (UPS).

The processor 68 of the transceiver module 64 is also connected to a single pulse output to activate a third party alarm control system or radio, to advise an alarm response service of generation of an alarm by one of the security devices 52.

As can be seen from FIG. 5, the system 50 includes a plurality of the transceiver modules situated at respective cemeteries, to relay to the control station 90 any alarm signal generated by any one of a plurality of security devices 52 mounted on respective gravestones. The control station 90 includes a GSM communication device 76 for receiving the alarm messages from any of the transceiver module 64 via the GSM network 74, and to communicate information contained in these messages to a monitoring server 78 in the form of a computer system managing an information database 86.

The database 86 has stored therein information on the identification code of each security device 52, as well as a notification address to which a notification message is to be sent in the event of generation of an alarm signal by the associated device 52. These notification addresses may be cellular telephones, landline telephones with messaging capability, or they may be e-mail addresses. The GSM module 76 is thus configured to send an electronic text message to each notification address when the associated security device 52 raises an alarm. The notification messages will typically be telephonic text messages, such as SMS messages, but can also be e-mail messages or any other type of text message which can be communicated electronically.

Although not shown in FIG. 4, the monitoring server 78 forms part of a wider computer system which includes operator workstations at which human operators can respond to alarm signals generated by any one of the security devices 52. The computer system can also include supervisor workstations and management workstations to permit maintenance and management of the system 50.

When theft or am authorised the removal of one of the protected memorial structures is attempted, the tilt sensor 54 of the associated security device 52 senses excessive tilting of that headstone, and automatically triggers the production of a radio frequency alarm signal by the antenna 62. The alarm signal 62 includes a unique identification code generated by the processor 58, thus enabling the identification of the particular security device 52 from which the alarm signal originated.

The alarm signal is received by the antenna 66 of the transceiver module 64 provided at the cemetery, and is relayed by the GSM module 72 of the transceiver module 64 to the control station 90 via the GSM network 74. The transceiver module 64 also automatically produces a single pulse output to an alarm response service.

Upon reception of an alarm message or alarm signal from the transceiver module 64, the monitoring server 78 processors the message to identify the identification code of the security device 52, as well as noting from which transceiver module 64 the message was sent. The server 78 then interrogates the database 86 to establish the notification addresses associated with the identified security device 52, and automatically sends notification messages by SMS or e-mail to each notification address. These notification addresses will typically be the those of next of kin of a person whose gravesite has been disturbed, but can also include a cellular telephones or the like of the associated cemetery's management and/or an alarm response service.

The invention as described and illustrated thus provides a means of notifying a family member or other designated party when a gravestone or memorial of a relative or friend has, for whatever reason, been disturbed. This is expected to be particularly advantageous, as, especially in rural areas, the next of kin of a late family member are not always closely located to the gravesite and therefore do not frequent the gravesite. Thus, as soon as maintenance or repairs to a gravestone or memorial is required, the designated party will automatically be notified and can then investigate the matter further and repair or fix the gravestone or memorial if required. Further, the invention as described and illustrated also provides for tracking of stolen headstone portions of gravestones or memorials.

23. A memorial assembly which includes:
a memorial structure, which is of composite construction;
a security device secured to the memorial structure, the security device including a sensing device for sensing disturbance of the memorial structure, and a transmitter operatively connected to the sensing device to generate a wireless alarm signal in response to sensing of disturbance of the memorial structure by the sensing device, the sensing device being configured to generate the alarm signal in response to separation of two parts of the memorial structure.

24. The memorial assembly as claimed in claim 23, which includes an electronic processor connected to the sensing device and to the transmitter, to process electronic signals received from the sensing device, and to cause the transmitter to transmit an alarm signal in response to sensing of disturbance of the memorial structure, the processor being configured to generate unique identification information for inclusion in the alarm signal, to enable identification of the particular security device from which an alarm signal originates.

25. The memorial assembly as claimed in claim 24, in which the sensing device includes an orientation sensor which is configured to sense the orientation of at least part of the memorial structure, and to cause generation of the alarm signal when the measured orientation of at least part of the memorial structure falls outside of prespecified orientation parameters.

26. The memorial assembly as claimed in claim 25, in which the orientation sensor is a tilt sensor for sensing when a part of the memorial structure on which the tilt sensor is mounted is tilted by more than a prespecified angle from an operative position, the orientation sensor being configured to trigger generation of an alarm signal if the part of the memorial structure on which the tilt sensor is mounted is tilted by more than 45° from its operative position.

27. The memorial assembly as claimed in claim 26, in which the memorial structure comprises a headstone portion which is supported on and secured to a base portion, the tilt sensor being mounted on the headstone portion to sense tilting of the headstone portion.

28. The memorial assembly as claimed in claim 23, in which the memorial structure includes a headstone portion and a base portion on which the headstone portion is supported, the sensing device being fixedly secured to the memorial structure such that it senses displacement or removal of the headstone portion relative to the base portion.

29. The memorial assembly as claimed in claim 28, in which the headstone portion is secured to the base portion by at least one securing rod, each rod being received in a pair of complementary aligned passages provided in the base portion and the headstone portion respectively, each passage in the base portion intruding from an operatively upper face of the base portion, and each passage in the headstone portion intruding from an operatively lower face of the headstone portion, the upper and lower faces of the base portion and the headstone portion abutting, when the memorial structure is in its operative condition, the sensing device including a separation sensor having an elongated casing which is fixedly secured in complementary aligned passages in the headstone portion and the base portion, the casing having a zone of weakness more or less aligned with the abutment between the base portion and the headstone portion, the separation sensor being configured to sense damage, such as breakage, of the casing in the zone of weakness and, in response thereto, to trigger generation of the alarm signal.

30. The memorial assembly as claimed in claim 27, in which the security device includes a tracking device which is located in the headstone portion, so that it moves with the headstone portion if the headstone portion is removed, the tracking device producing a tracking signal for facilitating location of the headstone portion.

31. The memorial assembly as claimed in claim 30, in which the tracking device is fixedly secured to the headstone portion, to inhibit unauthorised removal of the tracking device.

32. The memorial assembly as claimed in claim 23, in which the transmitter is configured for transmitting a radio frequency alarm signal to a remote station.

33. The memorial assembly as claimed in claim 32, in which the transmitter is configured to transmit the alarm signal to at least one mobile telephone device.

34. The memorial assembly as claimed in claim 23, in which the transmitter is arranged to transmit an electronic text message to at least one specified address.

35. The memorial assembly as claimed in claim 24, which includes a mobile power source, such as a battery, connected to both the sensing device and the transmitter, and in which the transmitter is configured for producing a radio frequency alarm signal with a localised range, to transmit the alarm signal to a transceiver module located in relative proximity to the memorial assembly.

36. A memorial security system which includes:
a memorial assembly as claimed in claim 23;
a transceiver module located within range of the transmitter of the memorial assembly, to receive the alarm signal and to produce at least one notification message to prespecified notification address.

37. The memorial security system as claimed in claim 36, in which the transceiver module includes a mobile telephone communication module for communicating the notification signal to each prespecified notification address via a cellular telephone network, and which includes an information database having stored thereon an identification information of each of a plurality of security devices, as well as at least one notification address associated with each security device, the system being operable to identify unique identification information in any alarm signal generated by a security device, and to interrogate the database to establish each associated notification address.

38. The memorial security system as claimed in claim 37, in which the transceiver module is installed at a memorial site so that it is within range of at least one security device mounted on a memorial structure at that memorial site, the transceiver module having a communication means for communicating the notification signal or the alarm signal to a remote control station.

39. The memorial security system as claimed in claim 38, which includes a plurality of transceiver modules installed at respective memorial sites, each transceiver module being operable to transmit notification signals or alarm signals to the control station.

40. The memorial security system as claimed in claim 36, which includes a notification messaging arrangement for sending a text notification message to each prespecified notification address.

41. The memorial security system as claimed in claim 40, in which the notification messaging arrangement is configured for generating telephonic text messages.

42. A method of securing a memorial structure of composite construction, which method includes:
attaching a security device to the memorial structure;
monitoring the memorial structure by the security device, to sense separation of two parts of the memorial structure; and
automatically generating an alarm signal in response to measurement of separation of the parts of the memorial structure by the security device.

43. The method as claimed in claim 42, which comprises generating the alarm signal in response to sensing that a part of the memorial structure on which the security device is mounted has been tilted beyond prespecified parameters.

44. The method as claimed in claim 42, which includes sending an electronic text message to at least one prespecified notification address in response to generation of the alarm signal.
